(19) United States
(12) Patent Application Publication
(10) Pub. No.: US 2026/0197748 A1
(43) Pub. Date: Jul. 9, 2026

(54) COMMUNICATION METHOD AND APPARATUS, AND DEVICE AND STORAGE MEDIUM

(71) Applicant: Beijing Xiaomi Mobile Software Co., Ltd., Beijing (CN)

(72) Inventor: Jianning LIU, Beijing (CN)

(73) Assignee: Beijing Xiaomi Mobile Software Co., Ltd., Beijing (CN)

(21) Appl. No.: 18/862,469

(22) PCT Filed: May 6, 2022
(86) PCT No.: PCT/CN2022/091207

§ 371 Date: Nov. 1, 2024

(51) Int. Cl. H04W 48/16; H04L 67/51; H04W 48/14; H04W 84/12

(52) U.S. Cl. CPC H04W 48/16; H04L 67/51; H04W 48/14; H04W 84/12

(57) ABSTRACT

A communication method includes transmitting a first request message to an access and mobility management function (AMF) network element. Where the first request message is configured to query for service information of a personal internet of things (IoT) network (PIN).

### CROSS REFERENCE TO RELATED APPLICATIONS

This application is a National Phase of International Application No. PCT/CN2022/091207, filed on May 6, 2022, the entire contents of which are incorporated herein by reference in their entireties.

### TECHNICAL FIELD

The present disclosure relates to the field of communication technologies and in particular to communication methods and apparatuses, devices and storage mediums.

### BACKGROUND

In the prior art, when discovering services of a personal internet of things (IoT) network (PIN), a terminal device usually discovers the services of the PIN via broadcast messages provided by PIN elements with gateway capability (PEGC) or PIN elements with management capability (PEMC) in the PIN. But how to discover the services of the PIN via a core network like a 5th generation (5G) core network has not been solved yet.

### SUMMARY

One or more embodiments of the present disclosure provide communication methods, apparatuses and devices and storage mediums for querying for service information of personal internet of things network (PIN).

According to a first aspect of the embodiments of the present disclosure, there is provided a communication method, performed by a terminal device, and including: transmitting a first request message to an access and mobility management function (AMF) network element, where the first request message is configured to query for service information of a personal internet of things (IoT) network (PIN).

According to a second aspect of the embodiments of the present disclosure, there is provided a communication method, performed by an access and mobility management function (AMF) network element and including: receiving a first request message from a terminal device, where the first request message is configured to query for service information of a PIN.

According to a third aspect of the embodiments of the present disclosure, there is provided a communication method, performed by a personal internet of things (IOT) network (PIN) management function (PMF) network element, and including: receiving a second request message from an AMF network element, where the second request message is configured to query for service information of a PIN.

According to a fourth aspect of the embodiments of the present disclosure, there is provided a terminal device, including: a processor; and a memory storing computer programs executable by the processor, where the computer programs; when executed by the processor, cause the processor to perform the communication method of the first aspect.

According to a fifth aspect of the embodiments of the present disclosure, there is provided an access and mobility function (AMF) network element, including: a processor; and a memory storing computer programs executable by the processor; where the computer programs, when executed by the processor, cause the processor to perform the communication method of the second aspect.

According to a sixth aspect of the embodiments of the present disclosure, there is provided a PMF network element, including: a processor; and a memory storing computer programs executable by the processor; where the computer programs, when executed by the processor, cause the processor to perform the communication method of the third aspect.

Additional aspects and advantages of the embodiments of the present disclosure will be partly given in the following descriptions and will become apparent from the following descriptions or be known by practice of the present disclosure.

### BRIEF DESCRIPTION OF THE DRAWINGS

In order to more clearly describe the technical solutions of the present disclosure, the drawings required for descriptions of the embodiments of the present disclosure will be briefly introduced. Apparently, the drawings described hereunder are only some embodiments of the present disclosure. Those skilled in the arts can obtain other drawings based on these drawings without carrying out creative work.

FIG. 1 is a flowchart illustrating a communication method according to an embodiment of the present disclosure.

FIG. 2 is a flowchart illustrating a communication method according to another embodiment of the present disclosure.

FIG. 3 is a flowchart illustrating a communication method according to yet another embodiment of the present disclosure.

FIG. 4 is a schematic diagram illustrating a time sequence of a communication method according to an embodiment of the present disclosure.

FIG. 5 is a structural schematic diagram illustrating a communication apparatus according to an embodiment of the present disclosure.

FIG. 6 is a structural schematic diagram illustrating a communication apparatus according to another embodiment of the present disclosure.

FIG. 7 is a structural schematic diagram illustrating a communication apparatus according to yet another embodiment of the present disclosure.

FIG. 8 is a structural schematic diagram illustrating an electronic device according to an embodiment of the present disclosure.

### DETAILED DESCRIPTION OF THE EMBODIMENTS

The wording “and/or” in the present disclosure describes an association relationship of an associated object, and indicates that three relationships may exist, e.g., A and/or B, which may be expressed as: A alone, both A and B, and B alone. The character “/” generally indicates an “or” relationship between the related objects.

The wording “plurality” in the present disclosure means two or more, and other quantifiers are similar.

Examples will be described in detail herein, with the illustrations thereof represented in the drawings. Where the following description relates to the drawings, unless otherwise indicated, the same numerals in different drawings represent the same or similar elements. Implementations described in the following examples do not represent all implementations consistent with the present disclosure. On the contrary, they are examples of an apparatus and a method consistent with some aspects of the present disclosure described in detail in the appended claims.

The terminology used herein is for the purpose of describing particular embodiments only and is not intended to be limiting of the present disclosure. As used herein, the singular forms “a”, “said” and “the” are intended to include the plural forms as well, unless the context clearly indicates otherwise. It will also be understood that as used herein, the term “and/or” is and includes any or all combinations of one or more of the associated listed items.

It will be understood that while terms such as “first”, “second”, “third”, etc. may be used to describe to describe various information, such information should not be limited to these terms. These terms are used only to distinguish the same type of information from each other. For example, without departing from the scope of the present disclosure, a first information may also be referred to as a second information, and similarly, a second information may also be referred to as a first information. Depending on the context, as used herein, the wording “if” may be interpreted as “while . . . ” or “when . . . ” or “in response to a determination”.

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the embodiments of the present disclosure without creative efforts shall fall within the protection scope of the present disclosure.

The method and the apparatus are based on the same conception, and since the method and the apparatus solve problems on similar principles, the implementations of the apparatus and the method can be referred to each other, and the repetitions will not be repeated.

The embodiments of the present disclosure relate to a terminal device, which may be a device that provides voice and/or data connectivity to a user, a handheld device with wireless connectivity, or other processing device connected to a wireless modem, and the like. The name of the terminal device may also vary in different systems, e.g., in a 5G system, the terminal device may be referred to as a user equipment (UE). A wireless terminal device can communicate with one or more core networks (CN) via a radio access network (RAN). The wireless terminal device can be a mobile terminal device, such as a mobile phone (also known as a “cellular” phone) and a computer with a mobile terminal device. For example, the terminal device can be a portable, pocket sized, handheld, computer built-in, or on-board mobile device that exchange language and/or data with the RAN. For example, a personal communication service (PCS) phone, a cordless phone, a session initiated protocol (SIP) phone, a wireless local loop (WLL) station, a personal digital assistant (PDA) and other devices. The wireless terminal device can also be referred to as a system, a subscriber unit, a subscriber station, a mobile station, a remote station, an access point, a remote terminal, an access terminal, a user terminal, a user agent, and a user device.

The terminal device can also be a personal internet of things (IoT) network (PIN) element (PINE) in the PIN, which can be a wearable device, a smart home device, or a smart office device, etc., and is not limited to the embodiments of the present disclosure.

The core network involved in the embodiments of the present disclosure can be a core network in various communication systems, especially in a 5G system. For example, the communication system can be a global system of mobile communication (GSM) system, a code division multiple access (CDMA) system, a wideband code division multiple access (WCDMA) system, a general packet radio service (GPRS) system, a long term evolution (LTE) system, a LTE frequency division duplex (FDD) system, a LTE time division duplex (TDD) system, a long term evolution advanced (LTE-A) system, an universal mobile telecommunication system (UMTS), a worldwide interoperability for microwave access (WiMAX) system, a 5G new radio (NR) system, etc.

The base station involved in the embodiments of the present disclosure may include multiple cells that provide services for the terminal device. Depending on the specific application, the base station may also be referred to as an access point, or may be a device in an access network that communicates with a wireless terminal device through one or more sectors over the air interface, or other names. The base station may be used to interchange received air frames with internet protocol (IP) packets, acting as a router between the wireless terminal device and the rest of the access network, where the rest of the access network may include an internet protocol (IP) communication network. The base station involved in the embodiments of the present disclosure may be a base transceiver station (BTS) in global system for mobile communications (GSM) or code division multiple access (CDMA), a network device (Nodeb) in wide-band code division multiple access (WCDMA), an evolutionary network device (evolutionary node B, eNB or E-Nodeb) in long term evolution (LTE) system, a 5G base station (gNB) in 5G network architecture (Next Generation System), or a home evolved Node B (HeNB) or a relay node, a home base station (FEMTO), a pico base station (PICO), etc., that is not limited to the embodiments of the present disclosure. In some network architectures, a base station may include a centralized unit (CU) node and a distributed unit (DU) node, and the centralized unit and the distributed unit may also be arranged geographically separated.

Multi input multi output (MIMO) transmission can be performed between the base station and the terminal device by using one or more antennas respectively, and the MIMO transmission can be single user MIMO (SU-MIMO) or multiple user MIMO (MU-MIMO). According to the form and number of antenna combinations, MIMO transmission can be 2D-MIMO, 3D-MIMO, FD-MIMO, or Massive MIMO, as well as diversity transmission, precoding transmission, beamforming transmission, etc.

As shown in FIG. 1, an embodiment of the present disclosure provides a communication method. The method may be applied to a terminal device. The communication method shown in FIG. 1 may specifically include the following step S11.

At step S11, a first request message is transmitted to an Access and Mobility Management Function (AMF) network element, where the first request message is used to query for service information of a Personal Internet of Things Network (PIN).

In the communication method applied to the terminal device according to the present disclosure, as an example, transmitting the first request message to the AMF network element may include transmitting the first request message to the AMF via a base station.

As an example, the terminal device transmits the first request message to the base station and the base station transmits the first request message to the AMF network element.

In the communication method applied to the terminal device according to the present disclosure, as an example, the first request message includes a PIN identifier of a first PIN for indicating querying for the service information of the first PIN.

In other words, the terminal device transmits the first request message including the PIN identifier of the first PIN to the AMF network element, so as to query for the service information of the first PIN.

The PIN identifier may be relevant information for identifying the PIN, which includes but not limited to PIN ID or another identifier or the like, which is not limited herein.

The first PIN may include one or more PINs, and the PIN identifier may be pre-configured for the terminal.

As an example, the terminal device may transmit the first request message including the PIN identifiers of multiple PINs to query for the service information of the multiple PINs.

In the communication method applied to the terminal device according to the present disclosure, as an example, the method further includes: receiving a first response message from the AMF network element, where the first response message includes the service information of the first PIN.

As an example, the terminal device transmits the first request message to the AMF network element and receives the first response message including the service information of the first PIN from the AMF network element.

In the communication method applied to the terminal device according to the present disclosure, as an example, receiving the first response message from the AMF network element may include receiving the first response message from the AMF network element via the base station.

In the communication method applied to the terminal device according to the present disclosure, as an example, the service information of the first PIN includes PIN Element (PINE) information of at least one PINE in the first PIN.

In the communication method applied to the terminal device according to the present disclosure, as an example, the PINE information of each PINE includes at least one of PINE name, PINE identifier, PINE type, PINE service or valid time of PINE service.

The PINE identifier may be relevant information for identifying the PINE, which includes but not limited to PINE ID or another identifier or the like, which is not limited herein.

The PINE service is used to represent a service provided by the PINE, for example, printer service.

As an example, the PINE information of each PINE includes PINE ID, PINE service and valid time of PINE service.

The PINE information of each PINE further includes relevant information of the corresponding PINE, such as capability, availability and reachability and the like.

In the communication method applied to the terminal device according to the present disclosure, as an example, the service information of the first PIN received by the terminal device further includes the PIN identifier of the first PIN for indicating that the service information in the first response message is the service information of the first PIN.

In the communication method applied to the terminal device according to the present disclosure, as an example, in response to that the first response message includes the PINE information of at least one PINE, the terminal device may, based on the PINE information of a target PINE, communicate with the target PINE.

The target PINE is a PINE the terminal device determines based on each piece of PINE information in the first response message and desires to communicate with, namely, a PINE corresponding to the service that the terminal device desires to use.

As an example, the PINE information in the first response message includes PINE information of a printer and the terminal device may communicate with the printer based on the PINE information of the printer.

In the communication method applied to the terminal device according to the present disclosure, as an example, when communicating with the target PINE, the terminal device may communicate with the target PINE via a PEGC in the first PIN.

The first PIN includes multiple PINEs, for example, includes a PEGC, a PEMC and at least one other PINE.

The target PINE may be any PINE in the first PIN. When the target PINE is a PEGC in the first PIN, the terminal device may directly communicate with the target PINE.

In the communication method applied to the terminal device according to the present disclosure, as an example, when communicating with the target PINE, the terminal device may communicate with the PEGC in the first PIN via a core network (e.g. 5 g core network), and further communicate with the target PINE via the PEGC in the first PIN.

When the target PINE is the PEGC in the first PIN, the terminal device may communicate with the target PINE via the core network.

The terminal device communicates with the core network like the AMF network element via the base station.

In the communication method applied to the terminal device according to the present disclosure, as an example, communication between the target PINE and the PEGC can be carried out by non-3rd generation partnership project (3GPP) communication connection such as Bluetooth, Near Field Communication (NFC) and the like.

In the communication method applied to the terminal device according to the present disclosure, as an example, the first request message transmitted by the terminal device includes device information of the terminal device.

The device information of the terminal device includes at least one of device name, device identifier, device type, device service or valid time of device service.

The device identifier may be relevant information for identifying the device, which includes but not limited to device ID or another identifier or the like, which is not limited herein.

The device service is used to represent a service provided by the terminal device, for example, printer service.

The device information may further include relevant information of the device, such as capability, availability and reachability and the like.

As an example, the terminal device may be a PINE in a particular PIN and the device information may include at least one of PINE name, PINE identifier, PINE type, PINE service or valid time of PINE service.

With the device information of the terminal device, the AMF network element can, based on the device information, for example, the PINE information, determine whether the terminal device subscribes to the services of the first PIN and determine whether the terminal device has an authority to use the services of the first PIN, and thus in response to determining that the terminal device subscribes to the services of the first PIN and the terminal device has the authority to use the services of the first PIN, return the first response message.

In the communication method applied to the terminal device according to the present disclosure, as an example, the terminal device may subscribe to the services of the PIN from a PEMC in the PIN and obtain the authority to use the services of the PIN.

The terminal device may directly transmit relevant request message or information to a PEMC in any PIN to subscribe to the services of the PIN and/or obtain an authority to use the services of the PIN; or transmit relevant request message or information via the base station to the PEMC in the PIN to subscribe to the services of the PIN and/or obtain an authority to use the services of the PIN; or transmit relevant request message or information to the AMF network element or PMF network element via the base station to further transmit the relevant request message or information to the PEMC in the PIN via the AMF network element or PMF network element, so as to subscribe to the services of the PIN and/or obtain an authority to use the services of the PIN.

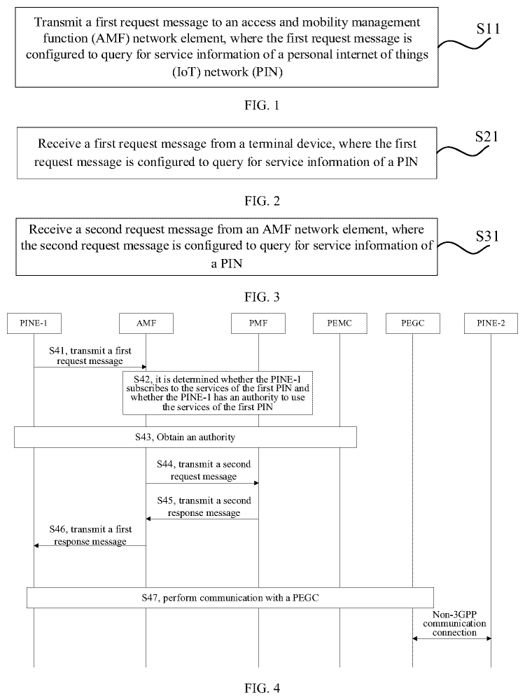

As shown in FIG. 2, an embodiment of the present disclosure provides a communication method. The method may be applied to an AMF network element. The communication method shown in FIG. 2 may specifically include the following step S21.

At step S21, a first request message is received from a terminal device, where the first request message is used to query for service information of a PIN.

The terminal device may be a PINE in the PIN, and the PINE may be a wearable device, a smart home device or a smart office device or the like, which is not limited herein.

In the communication method applied to the AMF network element according to the present disclosure, as an example, receiving the first request message from the terminal device may include receiving the first request message from the terminal device via a base station.

As an example, the terminal device transmits the first request message to the base station and the AMF network element receives the first request message from the base station.

In the communication method applied to the AMF network element according to the present disclosure, as an example, the first request message includes a PIN identifier of a first PIN for querying for the service information of the first PIN.

The PIN identifier may be relevant information for identifying the PIN, which includes but not limited to PIN ID or another identifier or the like, which is not limited herein.

The first PIN may include one or more PINs and the PIN identifier may be pre-configured for the terminal.

In the communication method applied to the AMF network element according to the present disclosure, as an example, the AMF network element may transmit a second request message for querying for the service information of the PIN to a PMF network element.

As an example, after receiving the first request message for querying for the service information of the PIN from the terminal device, the AMF network element transmits the second request message to the PMF network element.

In the communication method applied to the AMF network element according to the present disclosure, as an example, the second request message includes the PIN identifier of the PIN for indicating querying for the service information of the first PIN.

The PIN identifier may be relevant information for identifying the PIN, which includes but not limited to PIN ID or another identifier or the like, which is not limited herein.

In the communication method applied to the AMF network element according to the present disclosure, as an example, the method includes receiving a second response message from the PMF network element, where the second response message includes the service information of the first PIN.

As an example, the AMF network element transmits the second request message to the PMF network element and receives the second response message including the service information of the first PIN from the PMF network element.

In the communication method applied to the AMF network element according to the present disclosure, as an example, the PMF network element may be an independent network element in a core network, or a network element with another function in the core network, for example, a Unified Data Management (UDM) network element, or a network element with management function in the PIN, which is not limited herein.

As an example, the AMF network element may transmit the second request message to the UDM network element, where the second request message is used to query for the service information of the PIN.

As an example, the AMF network element may receive the second response message from the UDM network element, where the second response message includes the service information of the first PIN.

In the communication method applied to the AMF network element according to the present disclosure, as an example, the method further includes: transmitting a first response message to the terminal device, where the first response message includes the service information of the first PIN.

In the communication method applied to the AMF network element according to the present disclosure, as an example, transmitting the first response message to the terminal device may include transmitting the first response message to the terminal device via a base station.

In the communication method applied to the AMF network element according to the present disclosure, as an example, the service information of the first PIN includes PINE information of at least one PINE in the first PIN.

In the communication method applied to the AMF network element according to the present disclosure, as an example, the PINE information of each PINE includes at least one of PINE name, PINE identifier, PINE type, PINE service or valid time of PINE service.

The PINE identifier may be relevant information for identifying the PINE, which includes but not limited to PINE ID or another identifier or the like, which is not limited herein.

The PINE service is used to represent a service provided by the PINE, for example, printer service.

As an example, the PINE information of each PINE includes PINE ID, PINE service and valid time of PINE service.

The PINE information of each PINE further includes relevant information of corresponding PINE, such as capability, availability and reachability and the like.

In the communication method applied to the AMF network element according to the present disclosure, as an example, the service information of the first PIN received from the AMF network element may further include the PIN identifier of the first PIN for indicating that the service information in the second response message is the service information of the first PIN.

In the communication method applied to the AMF network element according to the present disclosure, as an example, the service information of the first PIN transmitted by the AMF network element to the terminal device may further include the PIN identifier of the first PIN for indicating that the service information in the first response message is the service information of the first PIN.

In the communication method applied to the AMF network element according to the present disclosure, as an example, the second request message transmitted by the AMF network element includes device information of the terminal device.

The device information of the terminal device includes at least one of device name, device identifier, device type, device service or valid time of device service.

The device identifier may be relevant information for identifying the device, which includes but not limited to device ID or another identifier or the like, which is not limited herein.

The device service is used to represent a service provided by the terminal device, for example, printer service.

The device information may further include relevant information of the device, such as capability, availability and reachability and the like.

As an example, the terminal device may be a PINE in a particular PIN and the device information may include at least one of PINE name, PINE identifier, PINE type, PINE service or valid time of PINE service.

In the communication method applied to the AMF network element according to the present disclosure, as an example, the first response message transmitted by the AMF network element includes the device information of the terminal device.

The device information of the terminal device includes at least one of device name, device identifier, device type, device service or valid time of device service.

The device identifier may be relevant information for identifying the device, which includes but not limited to device ID or another identifier or the like, which is not limited herein.

The device service is used to represent a service provided by the terminal device, for example, printer service.

The device information may further include relevant information of the device, such as capability, availability and reachability and the like.

As an example, the terminal device may be a PINE in a particular PIN and the device information may include at least one of PINE name, PINE identifier, PINE type, PINE service or valid time of PINE service.

In the communication method applied to the AMF network element according to the present disclosure, as an example, transmitting the second request message to the PMF network element includes: in response to determining that the terminal device already subscribes to the queried services of the first PIN and has an authority to use the services of the first PIN, transmitting the second request message to the PMF network element.

The AMF network element may, based on the device information of the terminal device, for example, the PINE information, determine whether the terminal device subscribes to the services of the first PIN and determine whether the terminal device has an authority to use the services of the first PIN.

Alternatively, the AMF network element may transmit the device information of the terminal device to the PMF network element, for example, transmit the device information by the second request message such that the PMF network element can, based on the device information of the terminal device, for example, the PINE information, determine whether the terminal device subscribes to the services of the first PIN and determine whether the terminal device has an authority to use the services of the first PIN.

As shown in FIG. 3, an embodiment of the present disclosure provides a communication method. The method may be applied to a PMF network element. The communication method shown in FIG. 3 may specifically include the following step S31.

At step S31, a second request message is received from the AMF network element, where the second request message is used to query for service information of a PIN.

In the communication method applied to the PMF network element according to the present disclosure, as an example, the second request message includes a PIN identifier of a first PIN for indicating querying for the service information of the first PIN.

The PIN identifier may be relevant information for identifying the PIN, which includes but not limited to PIN ID or another identifier or the like, which is not limited herein.

In the communication method applied to the PMF network element according to the present disclosure, as an example, the method further includes: transmitting a second response message to the AMF network element, where the second response message includes the service information of the first PIN.

As an example, the PMF network element receives the second request message from the AMF network element and transmits the second response message including the service information of the first PIN to the AMF network element.

In the communication method applied to the PMF network element according to the present disclosure, as an example, the PMF network element may be an independent network element in the core network, or a network element with another function in the core network, for example, a Unified Data Management (UDM) network element, or a network element with management function in the PIN, which is not limited herein.

As an example, the UDM network element may receive the second request message from the AMF network element, where the second request message is used to query for the service information of the PIN.

As an example, the UMD network element may transmit the second response message to the AMF network element, where the second response message includes the service information of the first PIN.

In the communication method applied to the PMF network element according to the present disclosure, as an example, the service information of the first PIN includes PINE information of at least one PINE in the first PIN.

In the communication method applied to the PMF network element according to the present disclosure, as an example, the PINE information of each PINE includes at least one of PINE name, PINE identifier, PINE type, PINE service or valid time of PINE service.

The PINE identifier may be relevant information for identifying the PINE, which includes but not limited to PINE ID or another identifier or the like, which is not limited herein.

The PINE service is used to represent a service provided by the PINE, for example, printer service.

As an example, the PINE information of each PINE includes PINE ID, PINE service and valid time of PINE service.

The PINE information of each PINE further includes relevant information of the corresponding PINE, such as capability, availability and reachability and the like.

In the communication method applied to the PMF network element according to the present disclosure, as an example, the service information of the first PIN transmitted by the PMF network element further includes the PIN identifier of the first PIN for indicating that the service information in the second response message is the service information of the first PIN.

In the communication method applied to the PMF network element according to the present disclosure, as an example, the second request message received by the PMF network element includes device information of the terminal device.

The device information of the terminal device includes at least one of device name, device identifier, device type, device service or valid time of device service.

The device identifier may be relevant information for identifying the device, which includes but not limited to device ID or another identifier or the like, which is not limited herein.

The device service is used to represent a service provided by the terminal device, for example, printer service.

The device information may further include relevant information of the device, such as capability, availability and reachability and the like.

As an example, the terminal device may be a PINE in a particular PIN and the device information may include at least one of PINE name, PINE identifier, PINE type, PINE service or valid time of PINE service.

In the communication method applied to the PMF network element according to the present disclosure, as an example, transmitting the second response message to the AMF network element includes: in response to determining that the terminal device already subscribes to the queried services of the first PIN and has an authority to use the services of the first PIN, transmitting the second response message to the AMF network element.

Determination on whether the terminal device subscribes to the services of the first PIN and whether the terminal device has an authority to use the services of the first PIN may be performed by the AMF network element based on the device information of the terminal device, for example, on the PINE information.

The AMF network element may transmit the device information of the terminal device to a PEMC in the first PIN such that the PEMC can determine whether the terminal device subscribes to the services of the PIN where it is located and whether the terminal device has an authority to use the services of the PIN where it is located.

In an embodiment of the present disclosure, the terminal device may query for the service information of the PIN via a core network and communicate with a target PINE in the PIN.

The communication method provided by the present disclosure will be further described in combination with FIG. 4, which includes steps S41-S47.

At step S41, a first request message is transmitted from PINE-1 to the AMF.

PINE-1 is a terminal device needing to query for service information of a PIN, and may be a PINE in other PINs than a first PIN.

The first request message includes PIN ID of the first PIN for indicating querying for the service information of the first PIN.

The first request message further includes PINE information of the PINE-1, based on which the AMF network element can determine whether the PINE-1 subscribes to the services of the first PIN and determine whether the PINE-1 has an authority to use the services of the first PIN.

The PINE-1 may transmit the first request message to the AMF network element via a base station (gNB).

At step S42, it is determined whether the PINE-1 subscribes to the services of the first PIN and whether the PINE-1 has an authority to use the services of the first PIN.

The AMF network element may determine whether the PINE-1 subscribes to the services of the first PIN and determine whether the PINE-1 has an authority to use the services of the first PIN.

The AMF network element may, based on the PINE information of the PINE-1, for example, PINE information, determine whether the PINE-1 subscribes to the services of the first PIN and determine whether the PINE-1 has an authority to use the services of the first PIN.

At step S43, an authority is obtained by the PINE-1.

When the PINE-1 does not subscribe to the services of the first PIN and/or does not have an authority to use the services of the first PIN, the PINE-1 subscribes to the services of the first PIN and/or obtains an authority to use the services of the first PIN via a PEMC in the first PIN.

At step S44, a second request message is transmitted.

After receiving the first request message from the PINE-1, the AMF network element transmits the second request message to the PMF network element.

The second request message includes the PIN ID of the first PIN for indicating querying for the service information of the first PIN.

The second request message may be PIN Service Query Request message or PINE Service Query Request message.

The PMF network element may be a UDM network element.

At step S45, a second response message is transmitted.

After receiving the second request message from the AMF network element, the PMF network element may transmit the second response message to the AMF network element.

The second response message includes PINE list information including the PINE information of at least one PINE in the first PIN.

The second response message further includes the PIN ID of the first PIN for indicating that the second response message includes the PINE information of at least one PINE in the first PIN.

At step S46, a first response message is transmitted.

After receiving the second response message, the AMF network element transmits the first response message to the PINE-1.

The first response message includes PINE list information including the PINE information of at least one PINE in the first PIN.

The first response message further includes the PIN ID of the first PIN for indicating that the first response message includes the PINE information of at least one PINE in the first PIN.

The first response message may be PIN Service Query Response message or PINE Service Query Response message.

At step S47, communication with a PEGC is performed.

After receiving the first response message, the PINE-1 may communicate with a PINE-2 based on PINE information of the PINE-2 in the PINE information in the first response message.

The PINE-1 may initiate PIN communication via the core network to communicate with the PEGC in the first PIN and further communicate with the PINE-2 via the PEGC in the first PIN.

The PINE-1 communicates with the core network via the base station.

The PINE-2 may communicate with the PEGC via non-3GPP communication connection such as Bluetooth, Near Field Communication (NFC) or the like.

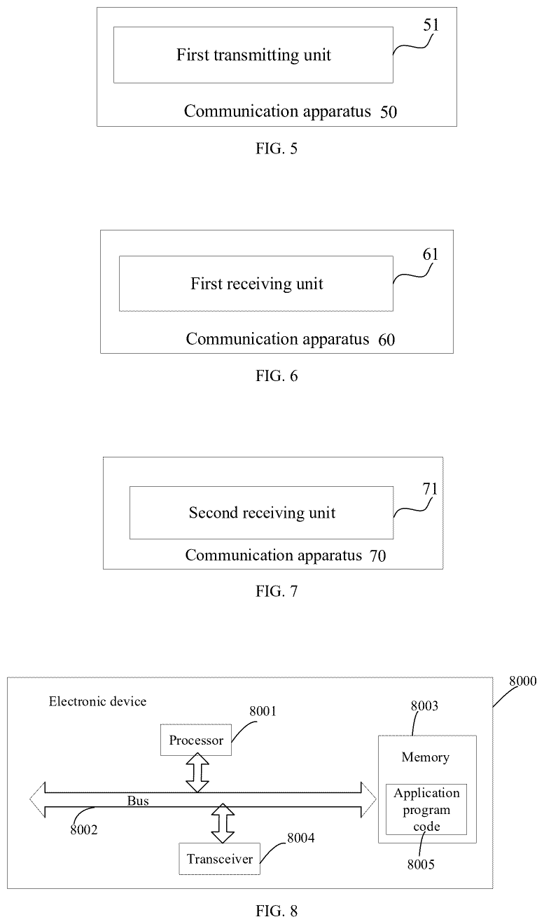

As shown in FIG. 5, the embodiments of the present disclosure provide a communication apparatus 50, and the communication apparatus 50 includes a first transmitting unit 51, which can be any type of device capable of sending/transmitting signals and/or data to other devices.

The first transmitting unit 51 is configured to transmit a first request message to an access and mobility management function (AMF) network element, where the first request message is configured to query for service information of a personal internet of things (IOT) network (PIN).

In an embodiment, the first request message includes a PIN identifier of a first PIN for indicating querying for the service information of the first PIN.

The communication apparatus 50 further includes a receiving unit (not shown), which can be any type of device capable of receiving signals and/or data from other devices and the receiving unit is configured to receive a first response message from the AMF network element, where the first response message includes the service information of the first PIN. The transmitting unit 51 can be a combination device capable of sending and receiving data.

In an embodiment, the service information includes PIN element (PINE) information of at least one PINE in the first PIN.

In an embodiment, the PINE information includes at least one of: a PINE name, a PINE identifier, a PINE type, a PINE service or valid time of a PINE service.

In an embodiment, the first transmitting unit 51 is further configured to transmit the first request message to the AMF network element via a base station.

In an embodiment, the service information further includes the PINE identifier.

In an embodiment, the communication apparatus 50 further a communication unit (not shown), and the communication unit is configured to communicate with a target PINE based on the PINE information of the target PINE.

In an embodiment, the communication unit (not shown) is further configured to communicate with the target PINE based on the PINE with gateway capability in the first PIN.

In an embodiment, the first request message further includes device information of the terminal device.

As shown in FIG. 6, the embodiments of the present disclosure provide a communication apparatus 60, and the communication apparatus 60 includes a first receiving unit 61, which can be any type of device capable of receiving signals and/or data from other devices.

The first receiving unit 61 is configured to receive a first request message from a terminal device, where the first request message is configured to query for service information of a personal internet of things (IoT) network (PIN).

In an embodiment, the communication apparatus 60 further includes a transmitting unit (not shown but can be, for example, a device corresponding to the transmitting unit 51), and the transmitting unit is configured to transmit a second request message to a PIN management function (PMF) network element, where the second request message is configured to query for the service information of the PIN. The first receiving unit 61 can be a combination device capable of sending and receiving data.

In an embodiment, the PMF network element is a unified data management (UDM) network element.

In an embodiment, the first request message and the second request message include a PIN identifier of a first PIN for indicating querying for the service information of the first PIN.

In an embodiment, the receiving unit 61 is further configured to receive a second response message from the PMF network element, where the second response message includes the service information of the first PIN.

In an embodiment, the transmitting unit is further configured to transmit a first response message to the terminal device, where the first response message includes the service information.

In an embodiment, the service information includes PIN element (PINE) information of at least one PINE in the first PIN.

In an embodiment, the PINE information includes at least one of: a PINE name, a PINE identifier, a PINE type, a PINE service or valid time of a PINE service.

In an embodiment, the transmitting unit is further configured to: in response to determining that the terminal device already subscribes to services of the first PIN and has an authority to use the services of the first PIN, transmit the second request message to the PMF network element.

In an embodiment, the service information further includes the PINE identifier.

In an embodiment, the first request message and the second request message further include device information of the terminal device.

As shown in FIG. 7, the embodiments of the present disclosure provide a communication apparatus 70, and the communication apparatus 70 includes a second receiving unit 71, which can be any type of device capable of receiving signals and/or data from other devices.

The second receiving unit 71 is configured to receive a second request message from an access and mobility management function (AMF) network element, where the second request message is configured to query for service information of a PIN.

In an embodiment, the PMF network element is a unified data management (UDM) network element.

In an embodiment, the second request message includes a PIN identifier of a first PIN for indicating querying for service information of the first PIN.

The communication apparatus 70 further includes a transmitting unit (not shown but can be, for example, a device corresponding to the transmitting unit 51), and the transmitting unit is configured to transmit a response message to the AMF network element, where the second response message includes the service information of the first PIN. The second receiving unit 71 can be a combination device capable of sending and receiving data.

In an embodiment, the service information includes PIN element (PINE) information of at least one PINE in the first PIN.

In an embodiment, the PINE information includes at least one of: a PINE name, a PINE identifier, a PINE type, a PINE service or valid time of a PINE service.

In an embodiment, the transmitting unit is further configured to: in response to determining that a terminal device already subscribes to services of the first PIN and has an authority to use the services of the first PIN, transmit the second response message to the AMF network element.

In an embodiment, the service information further includes the PINE identifier.

In an embodiment, the second request message further includes device information of the terminal device.

The embodiments of the present disclosure also provide an electronic device, as shown in FIG. 8, the electronic device 8000 may include: a processor 8001 and a memory 8003. The processor 8001 and the memory 8003 are connected, e.g., via a bus 8002. In an embodiment, the electronic device 8000 may also include a transceiver 8004, which can be used as any of the first transmitting unit 51, first receiving unit 61, or second receiving unit 71. It will be noted that the transceiver 8004 is not limited to one in number in practical applications, and the structure of the electronic device 8000 does not constitute a limitation of the embodiments of the present disclosure.

The memory 8003 is configured to store the application program code 8005 for executing the scheme of the present disclosure and is controlled for execution by processor 8001. When the processor 8001 serves as a terminal device, the processor 8001 is used to execute the application program code 8005 stored in the memory 8003 to implement the communication method applicable to the terminal device in any of the embodiments of the present disclosure. When the processor 8001 serves as an AMF network element, the processor 8001 is used to execute the application program code 8005 stored in the memory 8003 to implement the communication method applicable to the AMF network element in any of the embodiments of the present disclosure. When the processor 8001 serves as an PMF network element, the processor 8001 is used to execute the application program code 8005 stored in the memory 8003 to implement the communication method applicable to the PMF network element in any of the embodiments of the present disclosure.

The bus 8002 may include a pathway to transfer information between the foregoing components. The bus 8002 may be a peripheral component interconnect (PCI) bus or an extended industry standard architecture (EISA) bus, and so on. The bus 8002 may include an address bus, a data bus, a control bus, and so on. For ease of representation, only a thick line is shown in FIG. 8, but it does not mean that there is only one bus or one type of bus.

The memory 8003 may be a read only memory (ROM) or other type of static storage device that can store static information and instructions, a random access memory (RAM) or other type of dynamic storage device that can store information and instructions. It can also be an electrically erasable programmable read only memory (EEPROM), a compact disc read only memory (CD-ROM), CD-ROM) or other optical storage (including a compact disc, a laser disc, an optical disc, a digital versatile disc, a Blu-ray disc, etc.), magnetic storage medium or other magnetic storage devices, or any other medium that can be used to carry or store desired program codes in the form of instructions or data structures and can be accessed by a computer, but is not limited thereto.

Embodiments of the present disclosure provide a non-transitory computer-readable storage medium having computer programs stored thereon, which, when run on a computer, cause the computer to execute the corresponding contents of any of the method embodiments.

It will be understood that although the individual steps in the flowchart of the accompanying drawings are shown sequentially as indicated by arrows, the steps are not necessarily executed sequentially in the order indicated by the arrows. Unless expressly stated herein, there is no strict order limitation on the execution of these steps, which may be executed in some other order. At least a portion of the steps in the flowchart of the accompanying drawings may include a plurality of sub-steps or a plurality of phases, the sub-steps or phases are not necessarily executed to completion at the same moment but may be executed at different moments, and the order of execution thereof is not necessarily sequential, but may be executed in turn or in alternation with at least a portion of the other steps or sub-steps or phases of the other steps.

It will be noted that the computer-readable medium shown in the present disclosure may be a non-transitory computer readable signal medium or a non-transitory computer readable storage medium or any combination thereof. The non-transitory computer-readable storage medium may be, but is not limited to, an electrical, magnetic, optical, electromagnetic, infrared, or semiconductor system, apparatus, or component, or any combination thereof. More specific examples of the computer readable storage medium may include, but are not limited to: an electrical connection having one or more wires, a portable computer disk, a hard disk, a random access memory (RAM), a read-only memory (ROM), an erasable programmable read only memory (EPROM or a flash memory), an optical fiber, a portable compact disk read-only memory (CD-ROM), an optical storage device, a magnetic storage device, or any suitable combination thereof. In the present disclosure, the computer readable storage medium may be any tangible medium including or storing a program, and the program may be used by or in combination with an instruction execution system, apparatus, or device. In the present disclosure, the computer readable signal medium may be a data signal included in a baseband or propagated as a part of a carrier, in which computer readable program code is carried. This propagated data signal can take many forms, including but not limited to electromagnetic signals, optical signals, or any suitable combination thereof. The computer-readable signal medium may also be any computer-readable medium other than a computer-readable storage medium, and the computer-readable medium may send, propagate, or transmit a program for use by or in combination with an instruction execution system, an apparatus, or a component. The program code contained on the computer-readable medium may be transmitted using any appropriate medium, including but not limited to: wireless, wire, optical cable, RF, etc., or any suitable combination of the foregoing.

The non-transitory computer-readable storage medium may be included in the wireless local area network (LAN) initiating or responding device. Also, the computer-readable storage medium can exist independently without being assembled into the wireless LAN initiating or responding device.

The non-transitory computer-readable storage medium carries one or more programs, where the one or more programs, when executed by the wireless LAN initiating or responding device, cause the initiating or responding device to perform the corresponding communication method.

According to an aspect of the present disclosure, there is provided a computer program product or computer program including computer instructions which are stored in a non-transitory computer-readable storage medium. The processor of the computer device reads the computer instructions from a computer-readable storage medium, executes the computer instructions, and causes the computer device to perform the communication methods provided in the various optional implementations.

A program code for performing the operation of the present disclosure may be written by using any combination of one or more programming languages. The programming language includes an object-oriented programming language such as Java, C++, and a conventional procedural programming language such as a “C” Language or a similar programming language. The program code may be fully executed on a computer of a user or partially executed on a computer of a user, or may be executed as an independent software package, or may be partially executed on a computer of a user and partially executed on a remote computer, or may be fully executed on a remote computer or a server. In case of the remote computer, the remote computer may be connected to the computing device of a user by using any network including a local area network (LAN) or a wide area network (WAN), or may be connected to an external computer (for example, connected to the external computer through the Internet by using an Internet service provider).

Flowcharts and block diagrams in the drawings illustrate architectures, functions, and operations that may be implemented by using the system, the method, and the computer program product according to the various embodiments of the present disclosure. In this regard, each block in the flowchart or the block diagram may represent a module, a program segment, or a part of code. The module, the program segment, or the part of the code includes one or more executable instructions for implementing a specified logical function. It will also be noted that, in some alternative implementations, the functions noted in the blocks may occur in an order different from that noted in the drawings. For example, two blocks shown in succession can actually be executed in parallel, and sometimes they can also be executed in a reverse order, depending on the functions involved. It should also be noted that each block in the block diagrams and/or flowcharts, and combinations of blocks in the block diagrams and/or flowcharts, can be implemented with dedicated hardware-based systems that perform specified functions or operations, or a combination of dedicated hardware and computer instructions.

The modules described in the embodiments of the present disclosure may be implemented in software or hardware. A name of a module does not constitute a limitation on the module itself in some cases. For example, a module A can also be described as a “module A used to perform an operation B”.

The description is only some embodiments of the present disclosure and an explanation of the applied technical principles. Those skilled in the art should understand that the scope of the invention involved in the present disclosure is not limited to a technical solution formed by a specific combination of the technical features, but should also cover other technical solutions formed by any combination of the technical features or their equivalents without departing from the inventive concept of the present disclosure. For example, technical solutions formed by replacing the features with the technical features having similar functions disclosed in (but not limited to) the present disclosure.

1. A communication method, performed by a terminal device, and comprising:
transmitting a first request message to an access and mobility management function (AMF) network element, wherein the first request message is configured to query for service information of a personal internet of things (IoT) network (PIN).

2. The method of claim 1, wherein the first request message comprises a PIN identifier of a first PIN for indicating querying for the service information of the first PIN,
wherein the method further comprises:
receiving a first response message from the AMF network element, wherein the first response message comprises the service information of the first PIN,
wherein the service information comprises PIN element (PINE) information of at least one PINE in the first PIN, and
wherein the PINE information comprises at least one of: a PINE name, a PINE identifier, a PINE type, a PINE service, or valid time of a PINE service.

3-5. (canceled)

6. The method of claim 1, wherein transmitting the first request message to the AMF network element comprises:
transmitting the first request message to the AMF network element via a base station.

7. The method of claim 2, further comprising:
communicating with a target PINE based on the PINE information of the target PINE.

8. The method of claim 7, wherein communicating with the target PINE comprises:
communicating with the target PINE based on the PINE with gateway capability in the first PIN.

9. The method of claim 1, wherein the first request message further comprises device information of the terminal device.

10. A communication method, performed by an access and mobility management function (AMF) network element and comprising:
receiving a first request message from a first terminal device, wherein the first request message is configured to query for service information of a personal internet of things (IoT) network (PIN).

11. The method of claim 10, further comprising:
transmitting a second request message to a PIN management function (PMF) network element, wherein the second request message is configured to query for the service information of the PIN,
wherein the PMF network element is a unified data management (UDM) network element, and
wherein the first request message and the second request message comprise a PIN identifier of a first PIN for indicating querying for the service information of the first PIN.

12-13. (canceled)

14. The method of claim 11, further comprising:
receiving a second response message from the PMF network element, wherein the second response message comprises the service information of the first PIN.

15. The method of claim 14, further comprising:
transmitting a first response message to the terminal device, wherein the first response message comprises the service information,
wherein the service information comprises PIN element (PINE) information of at least one PINE in the first PIN, and
wherein the PINE information comprises at least one of: a PINE name, a PINE identifier, a PINE type, a PINE service, or valid time of a PINE service.

16-17. (canceled)

18. The method of claim 11, wherein transmitting the second request message to the PMF network element comprises:
in response to determining that the terminal device already subscribes to services of the first PIN and has an authority to use the services of the first PIN, transmitting the second request message to the PMF network element.

19. The method of claim 11, wherein the first request message and the second request message further comprise device information of the terminal device.

20. A communication method, performed by a personal internet of things (IoT) network (PIN) management function (PMF) network element, and comprising:
receiving a second request message from an access and mobility management function (AMF) network element, wherein the second request message is configured to query for service information of a PIN.

21. The method of claim 20, wherein the PMF network element is a unified data management (UDM) network element, and
wherein the second request message comprises a PIN identifier of a first PIN for indicating querying for service information of the first PIN.

22. (canceled)

23. The method of claim 21, further comprising:
transmitting a response message to the AMF network element, wherein the second response message comprises the service information of the first PIN,
wherein the service information comprises PIN element (PINE) information of at least one PINE in the first PIN, and
wherein the PINE information comprises at least one of: a PINE name, a PINE identifier, a PINE type, a PINE service, or valid time of a PINE service.

24-25. (canceled)

26. The method of claim 21, wherein transmitting the second response message to the AMF network element comprises:
in response to determining that a terminal device already subscribes to services of the first PIN and has an authority to use the services of the first PIN, transmitting the second response message to the AMF network element.

27. The method of claim 20, wherein the second request message further comprises device information of terminal device.

28-30. (canceled)

31. A terminal device, comprising: a processor; and a memory storing computer programs executable by the processor, wherein the computer programs; when executed by the processor, cause the processor to perform the communication method of claim 1.

32. An access and mobility management function (AMF) network element, comprising: a processor; and a memory storing computer programs executable by the processor; wherein the computer programs, when executed by the processor, cause the processor to perform the communication method of claim 10.

33. A personal internet of things (IoT) network (PIN) management function (PMF) network element, comprising: a processor; and a memory storing computer programs executable by the processor; wherein the computer programs, when executed by the processor, cause the processor to perform the communication method of claim 20.

34. (canceled)
